(19) United States
(12) Patent Application Publication
(10) Pub. No.: US 2023/0020294 A1
(43) Pub. Date: Jan. 19, 2023

(54) SCREEN SIZE ADJUSTMENT METHOD FOR LCD PROJECTORS

(71) Applicant: Shenzhen Yingling Jiguang Technology Co., Ltd, Shenzhen (CN)

(72) Inventors: Xiaocheng Huang, Shenzhen (CN); Jinglong Wang, Shenzhen (CN)

(21) Appl. No.: 17/864,168

(22) Filed: Jul. 13, 2022

(30) Foreign Application Priority Data
Jul. 15, 2021 (CN) 202110799223.9

(51) Int. Cl. H04N 9/31; G06F 8/20; G06F 8/38

(52) U.S. Cl. CPC H04N 9/3188; G06F 8/20; G06F 8/38

(57) ABSTRACT

The invention discloses a screen size adjustment method for LCD projectors, comprising a design of UI interface based on LCD display, a setting of zoom ratio threshold and a realization of UI zoom ratio function. The LCD projector screen size adjustment needs to be designed based on application scenarios and LCD display resolution (W_{Panel}×H_{Panel}) of the projector. A reasonable zoom ratio threshold is set based on the application scenario and product definition. After the zoom ratio threshold is determined, the system interface needs to be designed. When designing the system interface, the system interface resolution (W_{UI}×H_{UI}) should be determined according to the product of the screen resolution and the minimum value of the zoom ratio (Zₘᵢₙ), and the number of width and height pixels used in the final design of the system interface should not be higher than the value calculated above.

### 1. TECHNICAL FIELD

The invention relates to the field of projection technology, in particular to a screen size adjustment method for LCD projectors of multi-level fusion.

### 2. BACKGROUND ART

At present, the use of the projector is becoming more common, and the demand of the projector is also increasing; the number of existing users and potential users is the largest in portable LCD projection market. In this case, LCD projectors need to be able to meet the needs of customers for different application scenarios, which can adjust the screen size and provide customers with good projection ratio under complicated environments. The current products in the LCD projector market are all fixed focus. To change the size of the screen, the product position has to be adjusted or the lens has to be modified. Adjusting the product position requires the user to reinstall the product and is limited by the environment, which is inconvenient for the user, while modifying the lens focus will increase the cost.

### 3. SUMMARY OF THE INVENTION

The technical problem to be solved by the invention is to overcome the defects of the above technologies and provide a software-based screen size adjustment method for LCD projectors.

A screen size adjustment method for LCD projectors, comprising a design of UI interface based on LCD display, a setting of zoom ratio threshold and a realization of UI zoom ratio function.

The specific design is as follows: the LCD projector screen size adjustment needs to be designed based on application scenarios and the LCD display resolution (W_{Panel}×H_{Panel}) of the proj ector.

The reasonable zoom ratio threshold is set based on the application scenario and the product definition.

After the zoom ratio threshold is determined, the system interface needs to be designed.

When the system interface is designed, the system interface resolution (W_{UI}×H_{UI}) should be determined according to the product of the screen resolution and the minimum value of the zoom ratio (Zₘᵢₙ) and the calculation is as follows:

W_{UI}=W_{PANEL}×Zₘᵢₙ, the value should be rounded; (1-1)

H_{UI}=H_{PANEL}×Zₘᵢₙ, the value should be rounded; (1-2)

The number of width and height pixels used in the final design system interface should not be higher than the value calculated above.

Further, a software code needs to be added to realize the function of screen size adjustment for users after the design of zoom ratio threshold and the system UI interface are completed; when the output signal of the projection chip is sent to the display screen, the screen needs to be adjusted through a scaler, and the parameters of the scaler need to be changed through the software code to adjust the screen of the LCD display output from the chip.

In order to make the display transition smooth and the center of the display not deviate during zooming, the starting coordinates of the LCD screen (W_{Start}, H_{Start}) after zooming need to be calculated.

W_{Start}=(W_{Panel}−(W_{Panel}×R))/2, the value should be rounded; (1-3)

Hₛₜₐᵣₜ=(Hₛₜₐᵣₜ−(H_{Start}×R))/2, the value should be rounded; (1-4)

R: The current zoom scale.

The advantages of the invention over the prior art are as follows:

The invention can effectively help the user to reasonably adjust the screen zoom ratio according to the current environment condition when using the projector, so as to change the size of the projected screen, and obtain good use and visual experience.

### 4. BRIEF DESCRIPTION OF THE DRAWINGS

FIG. 1 is the design flow chart of the screen size adjustment function of the invention;

FIG. 2 is the reference coordinate system diagram for the screen size adjustment function of the invention to calculate the initial coordinate position of the screen;

FIG. 3 is the realization flow chart of the software in the screen size adjustment process of the invention;

FIG. 4 is the screen size adjustment process diagram of the invention. When the screen size is adjusted, the height and width of the display screen are synchronously adjusted to shrink to the center or extend to all sides, based on the center of the screen.

### 5. DETAILED DESCRIPTION OF THE PREFERRED EMBODIMENTS

The invention is further explained in detail hereinafter with reference to the drawings.

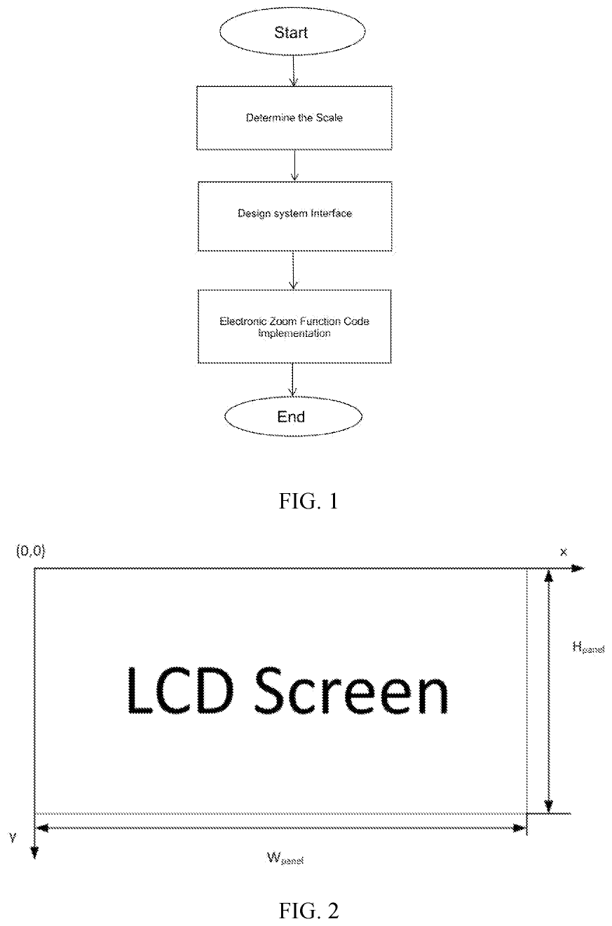

FIG. 1-4 show a software-based screen size adjustment method for LCD projectors.

A screen size adjustment method for LCD projectors, comprising a design of UI interface based on LCD display, a setting of zoom ratio threshold and a realization of UI zoom ratio function.

The specific design is as follows: the LCD projector screen size adjustment needs to be designed based on application scenarios and the LCD display resolution (W_{Panel}×H_{Panel}) of the proj ector.

The reasonable zoom ratio threshold is set based on the application scenario and the product definition.

After the zoom ratio threshold is determined, the system interface needs to be designed.

When the system interface is designed, the system interface resolution (W_{UI}×H_{UI}) should be determined according to the product of the screen resolution and the minimum value of the zoom ratio (Zₘᵢₙ) and the calculation is as follows:

W_{UI}=W_{PANEL}×Zₘᵢₙ, the value should be rounded; (1-1)

H_{UI}=H_{Panel}×Zₘᵢₙ, the value should be rounded; (1-2)

The number of width and height pixels used in the final design system interface should not be higher than the value calculated above.

For example, the product uses a landscape 1280*720 LCD display with a zoom ratio threshold of 75% to 100%; then the system interface height (H_{UI}) should not be greater than 720*75%=540 pixels and the width (W_{UI}) should not be greater than 1280*75%=960 pixels.

The software code needs to be added to realize the function of screen size adjustment for users after the design of zoom ratio threshold and the system UI interface are completed; when the output signal of the projection chip is sent to the display screen, the screen needs to be adjusted through a scaler, and the parameters of the scaler need to be changed through the software code to adjust the screen of the LCD display output from the chip.

In order to make the display transition smooth and the center of the display not deviate during zooming, the starting coordinates of the LCD screen (W_{Start}, H_{Start}) after zooming need to be calculated.

W_{Start}=(W_{Panel}−(W_{Panel}×R))/2, the value should be rounded; (1-3)

H_{Start}=(H_{Start}−(H_{Start}×R))/2, the value should be rounded; (1-4)

R: The current set of the zoom scale.

For example, when the zoom ratio is 80% and the LCD resolution is 1280*720, the starting coordinates of the screen should be as follows:

W_{Start}=(1280−(1280×80%))/2=128

H_{Start}=(720−(720×80%))/2=72

The realization of the screen size adjustment function is described as follows:

(1) define the global variable used to record the scale of the screen and give an initial value;

(2) according to the value of the global variable defined in Step 1, calculate the size of the screen that should be displayed. The calculation formula can be referred to (1-1) and (1-2). The calculation result should be rounded;

(3) type the screen size parameters calculated in Step 2 into the Scaler module inside the chip through the system function;

(4) the Scaler module completes the task of zoom ratio the screen according to the parameters in Step 3;

(5) under the condition that the center point of the screen remains unchanged, the program completes the task of calculating the starting position coordinates of the LCD display screen. The calculation formula can be referred to (1-3) and (1-4). The calculated coordinate values should be rounded, and the LCD reference coordinate system should be referred to the FIG. 2;

(6) the software will control Scaler to output the adjusted display from the calculated LCD starting position;

(7) when the screen size is adjusted, the system will first record the value of the zooming ratio into the global variable defined in Step 1;

(8) after Step 7 is completed, the system will reperform Step 2 to Step 6 to adjust the screen size;

(9) the system records the value of the variable defined in step 1 to the non-volatile memory to avoid data loss after power failure or shutdown.

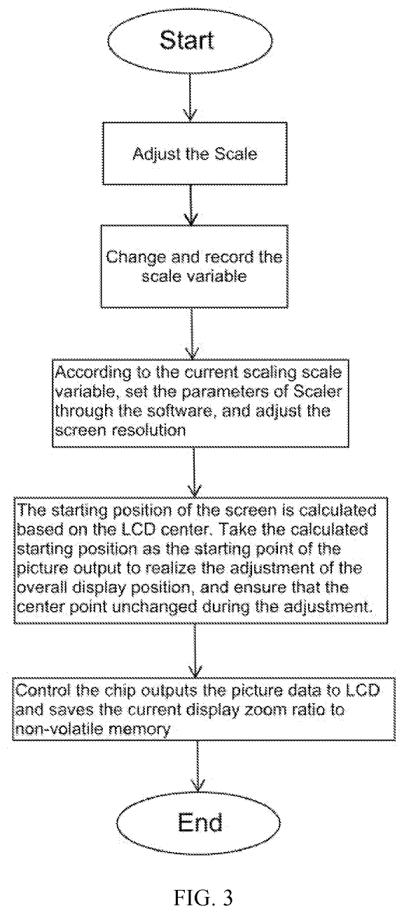

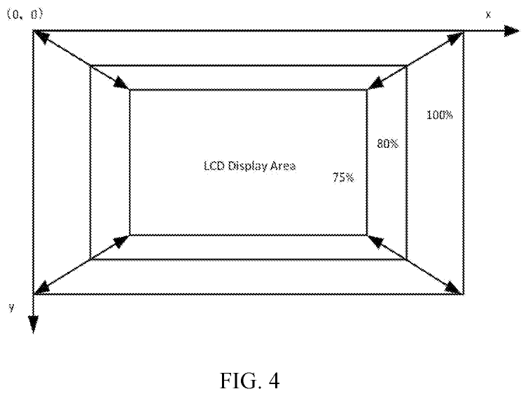

When the screen size is adjusted, the software execution process is shown in FIG. 3, and the screen zooming process is shown in FIG. 4.

The design process of the invention can be adjusted according to the situation, but the realization principle of the LCD screen size adjustment remains unchanged.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A screen size adjustment method for LCD projectors, comprising a design of UI interface based on LCD display, a setting of zoom ratio threshold and a realization of UI zoom ratio function;
the specific design is as follows: the LCD projector screen size adjustment needs to be designed based on application scenarios and the LCD display resolution (W_{Panel}×H_{Panel}) of the projector;
the reasonable zoom ratio threshold is set based on the application scenario and the product definition;
after the zoom ratio threshold is determined, the system interface needs to be designed;
when the system interface is designed, the system interface resolution (Wui x Hui) should be determined according to the product of the screen resolution and the minimum value of the zoom ratio (Zₘᵢₙ) and the calculation is as follows:
W_{UI}=W_{PANEL}×Zₘᵢₙ, the value should be rounded; (1-1)
H_{UI}=H_{Panel}×Zₘᵢₙ, the value should be rounded; (1-2)
the number of width and height pixels used in the final design system interface should not be higher than the value calculated above.

2. The screen size adjustment method for LCD projectors according to claim 1, wherein a software code needs to be added to realize the function of screen size adjustment for users after the design of zoom ratio threshold and the system UI interface are completed; when the output signal of the projection chip is sent to the display screen, the screen needs to be adjusted through a scaler, and the parameters of the scaler need to be changed through the software code to adjust the screen of the LCD display output from the chip.

3. A screen size adjustment method for LCD projectors according to claim 1, wherein in order to make the display transition smooth and the center of the display not deviate during zooming, the starting coordinates of the LCD screen(W_{Start}, H_{Start}) after zooming need to be calculated;
W_{Start}=(W_{Panel}−(W_{Panel}×R))/2, the value should be rounded; (1-3)
H_{Start}=(H_{Start}−(H_{Start}×R))/2, the value should be rounded; (1-4)
R: the current set of the zoom scale.
